(19) United States
(12) Patent Application Publication
(10) Pub. No.: US 2012/0102912 A1
(43) Pub. Date: May 3, 2012

(54) LOW COST CONTAINMENT RING

(76) Inventors: Said Izadi, San Diego, CA (US); Bohdan Skarzynski, San Diego, CA (US)

(21) Appl. No.: 12/912,814

(22) Filed: Oct. 27, 2010

(51) Int. Cl. F02C 7/00; B23P 19/00

(52) U.S. Cl. 60/39.091; 29/700

(57) ABSTRACT

A containment case for a turbine engine having a plurality of blades rotating therein has a first plurality of metallic layers each of the first plurality of layers being resistant to penetration of fragments therethrough and a second plurality of metallic layers, each of the second plurality of layers absorbing kinetic energy of fragments striking said second plurality of layers.

### BACKGROUND OF THE INVENTION

This invention relates to turbine engines having rotatable blade arrays and particularly to a containment case for confining blade, disk and impeller fragments which may fail during engine operation.

Gas turbine engines, such as those which power commercial aircraft, typically include multiple arrays of fans, compressors, turbine disks, and turbine blades. Each blade array comprises a multitude of blades that are attached to and extend radially outwardly from a hub. During engine operation each hub and associated blade array rotate about a longitudinally extending central axis. A non-rotating case, which is typically cylindrical or frustoconical in shape, circumscribes the tips of the blades and is radially spaced therefrom by a small amount. The case has a leading edge and a trailing edge, at least one of which is connected to an adjacent engine case. The case defines the outer boundary of a gas flow path that extends longitudinally through the engine.

During engine operation, it is possible for a fragment of a fan, compressor, turbine disk, and turbine blade to crack and become separated. Separation of a fragment is rare and is usually attributable to failure of a component. Because the kinetic energy of a blade fragment is considerable (particularly if the fragment comprises substantially the part of the disk/compressor) the fragment is capable of damaging engine and aircraft components which lie along the fragment's trajectory. To prevent such damage, the case which circumscribes a blade array is designed to confine or contain a fragment and is commonly referred to as a containment case.

One type of containment case is known as a softwall case. A softwall case comprises multiple layers of a light weight penetration resistant fabric wrapped around a rigid but penetrable support ring. A separated blade fragment will penetrate the support ring but be contained by the fabric. Softwall construction is expensive, but is also light weight, a distinct advantage in an aircraft application. A second type of case, known as a hardwall case, comprises a ring having sufficient radial thickness to resist penetration of a blade fragment. The choice of hard wall or soft wall construction depends largely on the case diameter and the temperature. For a large diameter case, hard wall construction is prohibitively heavy, and therefore soft wall construction, despite being expensive, is preferred. For a small diameter case, the radial thickness required for penetration resistance imposes only a modest weight penalty and so the less expensive hard wall construction is usually favored.

Although hard wall construction is almost universally preferred for small diameter cases, it is not without several disadvantages. First, the thickness and rigidity of a hard wall case prevent it from deflecting readily when struck by a blade fragment. Consequently, the full force of the impact is concentrated over a very short time interval and therefore is quite damaging. The abruptness and resultant severity of the impact contribute to the required thickness of the case and therefore to its weight. In addition, the severe impact energy is transmitted to auxiliary components, such as engine control units and pneumatic lines which may be attached to the exterior of the engine (and especially to the exterior of the containment case), thereby exposing those components to potentially damaging forces. A second disadvantage of a conventional hard wall containment case is that it is typically machined from forgings, which adds cost to the containment ring.

### SUMMARY OF THE INVENTION

According to an embodiment disclosed herein, a containment case for a turbine engine having a plurality of blades rotating therein has a first plurality of metallic layers each of the first plurality of layers being resistant to penetration of blades and disk fragments therethrough and a second plurality of metallic layers, each of the second plurality of layers absorbing kinetic energy of blades and disk fragments striking said second plurality of layers.

According to a further embodiment shown herein, a method for mounting layers that resist penetration of a blade or part thereof therethrough and absorb the kinetic energy thereof, includes providing a first plurality of metallic layers each of the first plurality of layers being resistant to penetration of blades therethrough, and providing a second plurality of metallic layers, each of the second plurality of layers absorbing kinetic energy of blades striking the any one of second plurality of layers.

According to a still further embodiment disclosed herein, a method of mounting a containment ring upon a portion of an engine within which a rotating component that may break or fragment is disposed includes providing a first plurality of metallic layers each of the first plurality of layers being resistant to penetration of fragments therethrough, providing a second plurality of metallic layers, each of the second plurality of layers absorbing kinetic energy of fragments striking one of second plurality of layers, and, disposing the first plurality of metallic layers and the second plurality of metallic layers about the portion.

These advantages and the features and operation of the invention will become more apparent in light of the following description of the best mode for carrying out the invention and the accompanying drawings.

### BRIEF DESCRIPTION OF THE DRAWINGS

FIG. 1 is a schematic, cross sectional side view of an aircraft gas turbine engine.

FIG. 2 is a cross sectional side view of an embodiment of a containment device used in the aircraft gas turbine engine of FIG. 1.

FIG. 3 is a cross sectional side view of the containment device of FIG. 2.

FIG. 4 is a perspective view of the containment device of FIG. 2.

FIG. 5 shows an embodiment method of constructing the containment device of FIG. 4

FIG. 6 shows a further embodiment method of constructing the containment device of FIG. 4

FIG. 7 shows an embodiment method of constructing the engine of FIG. 1.

### DETAILED DESCRIPTION OF THE PREFERRED EMBODIMENT

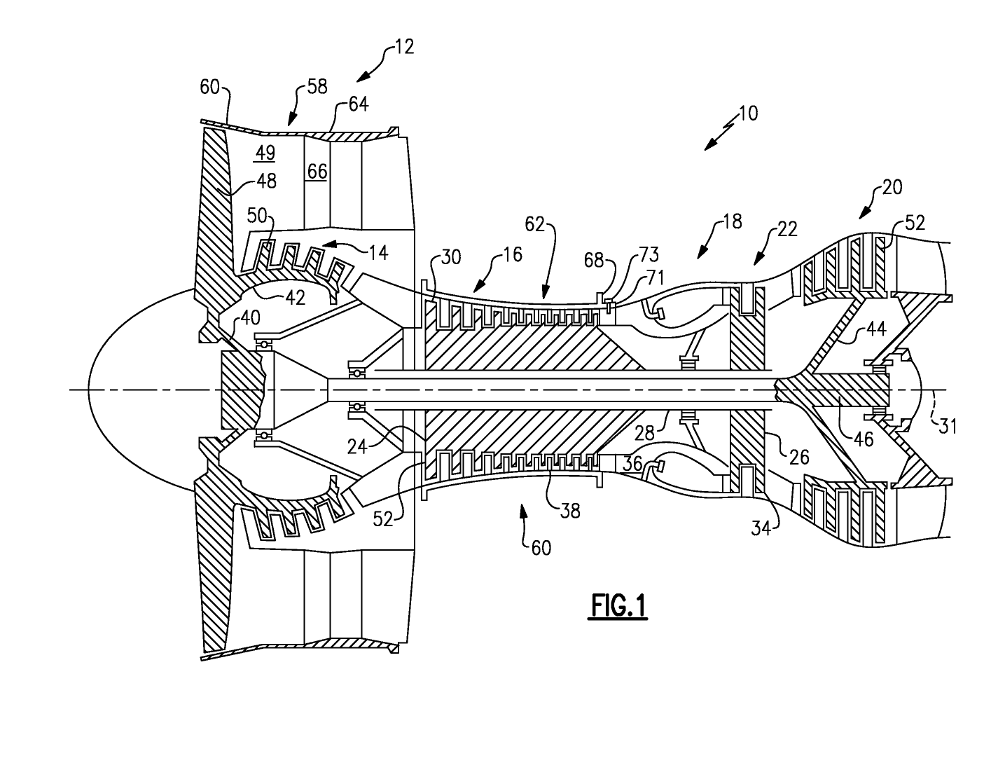

Referring to FIG. 1, an aircraft gas turbine engine 10 includes a fan 12, low pressure and high pressure compressors 14, 16, a combustion chamber 18, and low pressure and high pressure turbines 20, 22. The gas turbine engine 10 may be a main engine or incorporated in an auxiliary power unit of an aircraft. A high pressure rotor comprises a high pressure compressor hub 24 and a high pressure turbine hub 26 connected together by a shaft 28, and arrays of blades, such as representative compressor and turbine blades 30, 34. The blades extend radially outwardly from their respective hubs, across a primary flow path 36, and into close proximity with a primary or core case assembly 38. Similarly a low pressure rotor comprises fan, low pressure compressor and low pressure turbine hubs 40, 42, 44 connected together by shaft 46 and arrays of blades such as representative fan, low pressure compressor and low pressure turbine blades 48, 50, 52. Blades 48, 50, 52, extend radially outwardly from their respective hubs, across the primary flow path and, in the case of the fan blades 48, across a secondary flow path 49 as well, and into close proximity with the core case assembly 38, or a fan case assembly 58. The case assemblies define the outer flow path boundaries for the primary and secondary flow paths.

During engine operation, the turbines rotatably drive the fan and compressors about a longitudinally extending central axis 31. Since a fragment (not shown) may become separated from the rotor during engine operation, a containment case 60 has a particular structure, as will be discussed infra, to contain such a fragment. If a fragment, e.g., such as blade 52 or a fragment (not shown) thereof, breaks loose, that blade 52 or fragment has ballistic properties like a bullet and the containment case 60 deals with, as will be discussed infra, the penetration aspects associated with those ballistic properties. The case assembly 60 then absorbs the kinetic energy of the blade 52 to minimize damage to the engine 10.

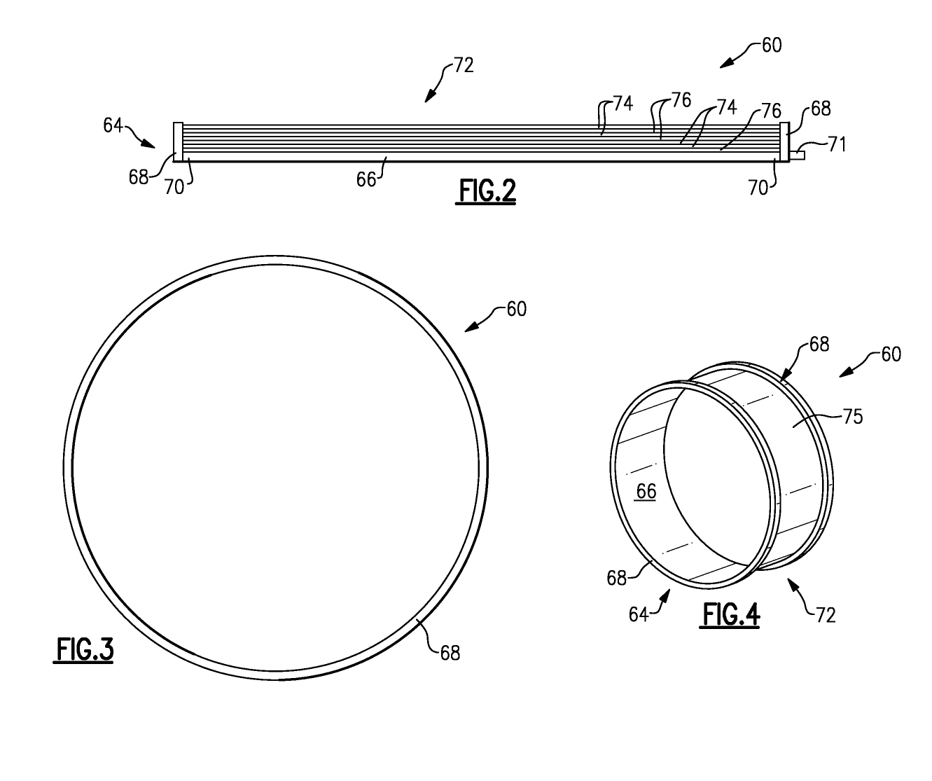

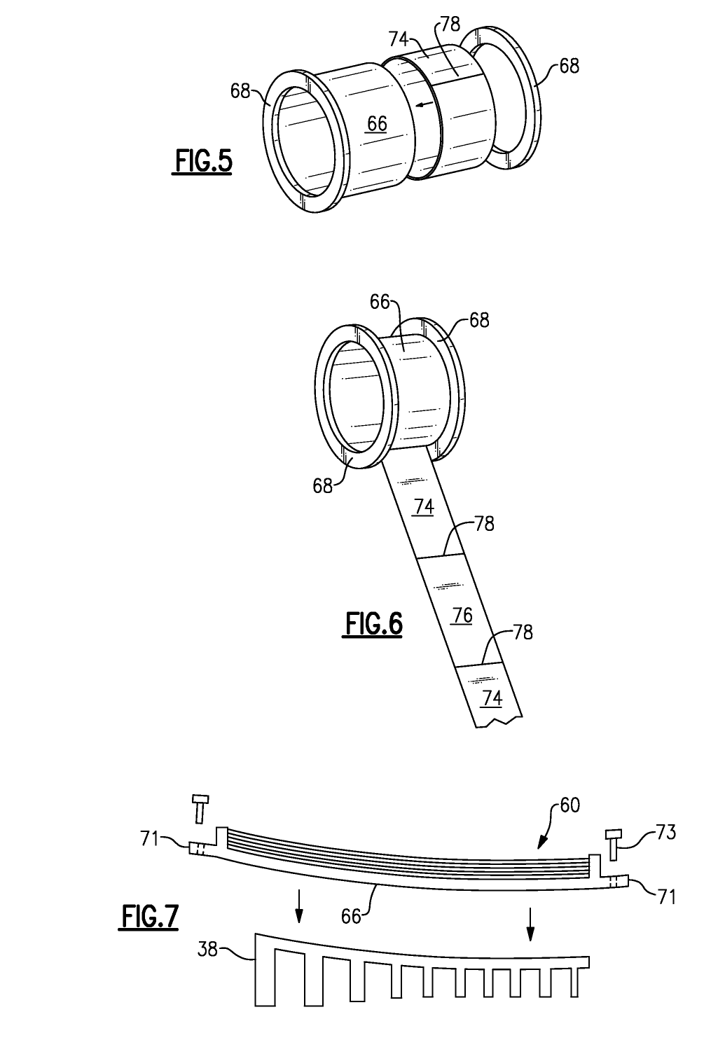

Referring to FIGS. 1-4, containment case 60 circumscribes an array of fan blades 52 as shown in FIG. 1. The containment case has an impact zone 62 that is a region where a separated blade fragment may strike the containment case. The containment case 60 includes: a spool 64 that has a base 66, shown as cylindrical in FIGS. 2-6, and a pair of rings 68 attached, by brazing or the like, to and extending from each end 70 of the cylindrical base 66 to define the spool 64; and, a plurality of layers 72 disposed around the spool 64 between the rings 68. Each ring 68 has a flange 71 or the like through which a bolt 73 attaches the containment case 60 to the core case assembly 38 (see FIG. 1). The base 66 also be contoured to adapt to the surface of a core case assembly 38 or the like.

To attach the containment case 60 to the engine 10 (see FIG. 7), the containment case 60 is slid over the core case assembly 38 during construction of the engine 10 and bolted via bolts 73 through flange 71 to the core case assembly 38. Other attachment methods may be used such as welding or brazing or the like.

The spool 64 including cylindrical base 66, rings 68 and flange 71 are constructed of stainless steel or the like. The layers 72 are made up of a relatively high strength metallic layers 74 such as Inconel® 718 steel or others that address the ballistic penetrative properties of a separated blade, such as blade 52, or a fragment thereof, and relatively ductile metallic layers 76, such as Inconel® 625 steel to absorb the kinetic energy of a separated blade, such as blade 52, or a fragment thereof. Each layer 74 is between about 0.1 inches (or 0.25 cm) and 0.01 (or 0.03 cm) thick and each layer 76 is similarly between about 0.1 inches (or 0.25 cm) and 0.01 (or 0.03 cm) thick though different thicknesses may be used for different applications and other materials.

The layers 74, 76 may be interleaved or may be grouped depending on the required application (see FIG. 2). Each layer 74, 76 may be attached by butt welding (see line 78 in FIGS. 4-6) or the like to itself to form a strip upon the spool 64 or attached to itself and slid on the cylindrical base 66 and any already applied layer 74, 76, before a ring 68 is attached to the cylindrical base 66. Each subsequent layer 74, 76 gets larger in diameter. Additionally a layer 74 or 76 may be attached to an adjacent layer 74 or 76, welded to the cylindrical base 66 and rolled or coiled up upon the spool 64. The last layer 74, 76 is then attached to the rest of the spooled layers 72, 74.

In the event that a separated blade fragment strikes the containment case during engine operation, the containment case 60, owing to its layers 74 that primarily resist the penetration of the separated blade 52 or fragment thereof, and the layers 76 that primarily absorb the energy of the separated blade 52 or fragment thereof.

The invention has been described as a containment case for an array of compressor blades 52 in a turbine engine 10. However the invention is equally applicable to the fan 48 and turbine blade 52 arrays of a turbine engine and to any other type of machinery where it is desirable to confine separated component fragments. These and other changes and modifications to the invention can be made without departing from the spirit and scope of the appended claims.

Although the invention has been shown and described with respect to a best mode embodiment exemplary thereof, it should be understood by those skilled in the art that various modifications, changes, omissions and additions in the form and detail thereof may be made without departing from the spirit and scope of the invention.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A containment case for a turbine engine having a plurality of blades rotating therein, said containment case comprising:
a first plurality of metallic layers each of said first plurality of layers being resistant to penetration of fragments therethrough; and
a second plurality of metallic layers, each of said second plurality of layers configured to absorb kinetic energy of fragments striking said second plurality of layers.

2. The containment case of claim 1, wherein said first plurality of metallic layers and said second plurality of metallic layers are interleaved with each other.

3. The containment case of claim 1, wherein said first plurality of metallic layers and said second plurality of metallic layers are not interleaved with each other.

4. The containment case of claim 1 further comprising a base upon which said first and second plurality of layers are disposed.

5. The containment case of claim 3 further comprising a first ring disposed upon a first end of said base upon which said first and second plurality of layers are disposed.

6. The containment case of claim 4 further comprising a second ring disposed upon a second end of said base upon which said first and second plurality of layers are disposed such that said base and said first and second rings form a spool.

7. The containment case of claim 1 further comprising a casing within which blades rotate and which said first and second layers are disposed thereabout.

8. The containment case of claim 1 wherein each of said first and second plurality of layers are between about 0.25 cm and 0.03 cm thick.

9. A method for mounting layers that resist penetration of a blade or part thereof therethrough and absorb the kinetic energy thereof, said method comprising:
providing a first plurality of metallic layers each of said first plurality of layers being resistant to penetration of blades therethrough; and
providing a second plurality of metallic layers, each of said second plurality of layers absorbing kinetic energy of blades striking said any one of second plurality of layers.

10. The method of claim 9 further comprising:
providing a base layer upon which said first plurality of metallic layers and said second plurality of metallic layers are disposed.

11. The method of claim 10 further comprising:
attaching each of said first plurality of metallic layers and said second plurality of metallic layers to itself to form a ring; and
placing said layer on said base.

12. The method of claim 10 further comprising providing a first ring on a first end of said base.

13. The method of claim 12 further comprising:
attaching each of said first plurality of metallic layers and said second plurality of metallic layers to itself to form a ring; and
placing said layer on said base in proximity to said first ring.

14. The method of claim 12 further comprising:
placing a second ring on a second end of said base such that said base and said first and second ring form a spool.

15. The method of claim 10 further comprising:
attaching a first end of each of said first plurality of metallic layers and said second plurality of metallic layers to a second end thereof to form a ring on said base.

16. The method of claim 10 further comprising:
attaching a first end of one of said first plurality of metallic layers and said second plurality of metallic layers to a second end of another of said first plurality of metallic layers and said second plurality of metallic layers to form a strip; and
coiling said strip upon said base.

17. The method of claim 16 further comprising attaching a first end of said strip to said base.

18. The method of claim 17 further comprising attaching a second end of said strip to said strip.

19. A method of mounting a containment ring upon a portion of an engine within which a rotating blade that may break or fragment is disposed, comprising:
providing a first plurality of metallic layers each of said first plurality of layers being resistant to penetration of blades therethrough;
providing a second plurality of metallic layers, each of said second plurality of layers absorbing kinetic energy of blades striking said any one of second plurality of layers; and
disposing said first plurality of metallic layers and said second plurality of metallic layers about said portion.

20. The method of claim 19 further comprising anchoring said first plurality of metallic layers and said second plurality of metallic layers to said portion.

21. The method of claim 19 further comprising:
disposing said first plurality of metallic layers and said second plurality of metallic layers in a spool; and
anchoring said spool to said portion.
